(19) United States
(12) Patent Application Publication
(10) Pub. No.: US 2009/0033057 A1
(43) Pub. Date: Feb. 5, 2009

(54) Vehicle with a Variable-Camber Suspension Device

(76) Inventors: Francois Andre, Romagnat (FR); Michel Blondelet, Le Crest (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/282,238

(22) PCT Filed: Mar. 5, 2007
(86) PCT No.: PCT/EP2007/052059

§ 371 Date: Sep. 9, 2008

(30) Foreign Application Priority Data
Mar. 9, 2006 (FR) 06/02240

(51) Int. Cl. B60G 3/00

(52) U.S. Cl. 280/124.125

(57) ABSTRACT

A vehicle comprising a variable-camber suspension device, the suspension device (1) allowing a substantially vertical suspension movement and a camber movement of the wheel (2) with respect to the body (5) of the vehicle, the vertical suspension movement and the camber movement being substantially independent. The suspension device is connected to the body by connection means (6, 7) allowing a rotation (α) of the suspension device with respect to the body about a transverse axis of rotation.

The present invention relates to the connection between motor vehicles and the ground, in particular to suspension devices allowing a degree of wheel camber freedom with respect to the body of the vehicle. The invention relates more specifically to passenger cars.

Suspension devices have two main functions which must be performed simultaneously at all times during their operation. One of these functions is to suspend the vehicle, that is to say allow substantially vertical oscillations of each wheel as a function of the load applied to this wheel. The other function of these devices is to guide the wheel, that is to say control the angular position of the wheel plane.

The term “wheel plane” refers to the plane, associated with the wheel, which is perpendicular to the axis of the wheel and which passes through the center of the static area of contact with the ground when the wheel is vertical. The wheel plane thus defined is hence fixed to the wheel axis and its orientation varies like that of the wheel.

The angular position of the wheel plane with respect to the body of the vehicle is defined by two angles, the camber angle and the steering angle. The camber angle of a wheel is the angle which, in a transverse plane perpendicular to the ground, separates the wheel plane from the mid-plane of the vehicle.

The steering angle of a wheel is the angle which, in a horizontal plane parallel to the ground, separates the wheel plane from the mid-plane of the vehicle.

Patent Application EP 1070609 describes a suspension device allowing a degree of wheel camber freedom that is substantially independent of the suspension movements. The suspension movements are permitted by a multi-arm or double-wishbone system. The camber variations result from movements of the articulation points of the arms with respect to the body of the vehicle in a passive manner under the effect of forces acting on the vehicle and/or in an active manner using a controlled actuator.

International Application WO 01/72572 describes a suspension device in which the wheel support is the means which allows a degree of wheel camber freedom with respect to the suspension elements. This degree of freedom is controlled either in an active manner, for example by a cylinder actuator as a function of vehicle running parameters, or in a passive manner using the forces which are exerted on the wheel in the contact area.

International Application WO 04/058521 describes another wheel support device allowing a degree of wheel camber freedom with respect to the suspension elements. The camber means comprise a triple hinge coupled, on the one hand, to the wheel carrier and, on the other hand, to the suspension elements, said triple hinge comprising two flanges and two levers, each of the levers being respectively fixed to one of the two flanges, the levers being coupled, on the one hand, to the wheel carrier and, on the other hand, to the suspension elements.

Many other examples of suspension systems with variable camber exist. One feature common to all these supports and suspension devices with variable camber is that, with respect to conventional suspension devices, they comprise an additional mobility function which, besides the vertical suspension, allows the wheel to camber with respect to the body. The wheel camber movement with respect to the body takes place about a camber axis. This substantially horizontal axis is represented by a point in the camber plane. It has also been proposed to adopt an inclined position of the axis with respect to the horizontal in order to obtain steering effects at the same time as the camber effects. One difficulty has arisen in choosing the angle of inclination, since the ideal inclination in fact constitutes a trade-off in terms of the dynamic performance levels of the vehicle, these performance levels sometimes being mutually opposed. For example, an inclination which is favourable to high-speed stability may be unfavourable in terms of ride agility or comfort at moderate speed. It is therefore a particular objective of the invention to overcome this difficulty in choosing the inclination of the camber axis.

This objective is achieved by a vehicle comprising a variable-camber suspension device, the said suspension device allowing a substantially vertical suspension movement and a camber movement of the wheel with respect to the body of the vehicle, the vertical suspension movement and the camber movement being substantially independent, wherein the suspension device is connected to the body by connection means allowing a rotation of the suspension device with respect to the body about a transverse axis of rotation.

Preferably, the said connection means are configured so as to allow a rotation of the suspension device with respect to the body about a transverse axis of rotation situated vertically between the ground and the center of the wheel. Preferably, the transverse axis is situated longitudinally in front of the center of the wheel.

Preferably, with the camber movement of the wheel taking place about an instantaneous axis of rotation, the said connection means are configured such that the instantaneous axis of rotation is substantially horizontal when the wheel does not transmit any braking force and such that the instantaneous axis of rotation is inclined towards the front when the wheel transmits a braking force. Preferably again, the said connection means are configured such that the instantaneous axis of rotation is substantially horizontal when the suspension device bears its reference load and such that the instantaneous axis of rotation is inclined towards the front when the suspension device bears a vertical load which is greater than the said reference load.

Preferably again, the said connection means are configured such that the instantaneous axis of rotation is substantially horizontal when the wheel does not transmit any driving force and such that the instantaneous axis of rotation is inclined towards the front when the wheel transmits a driving force.

Preferably, the connection means are elastic articulations, the rotation of the suspension device being brought about by the deformation of the said articulations.

Preferably, the rotation of the suspension device is controlled by active control means as a function of vehicle running parameters.

The invention will be better understood with reference to the description of the figures, in which:

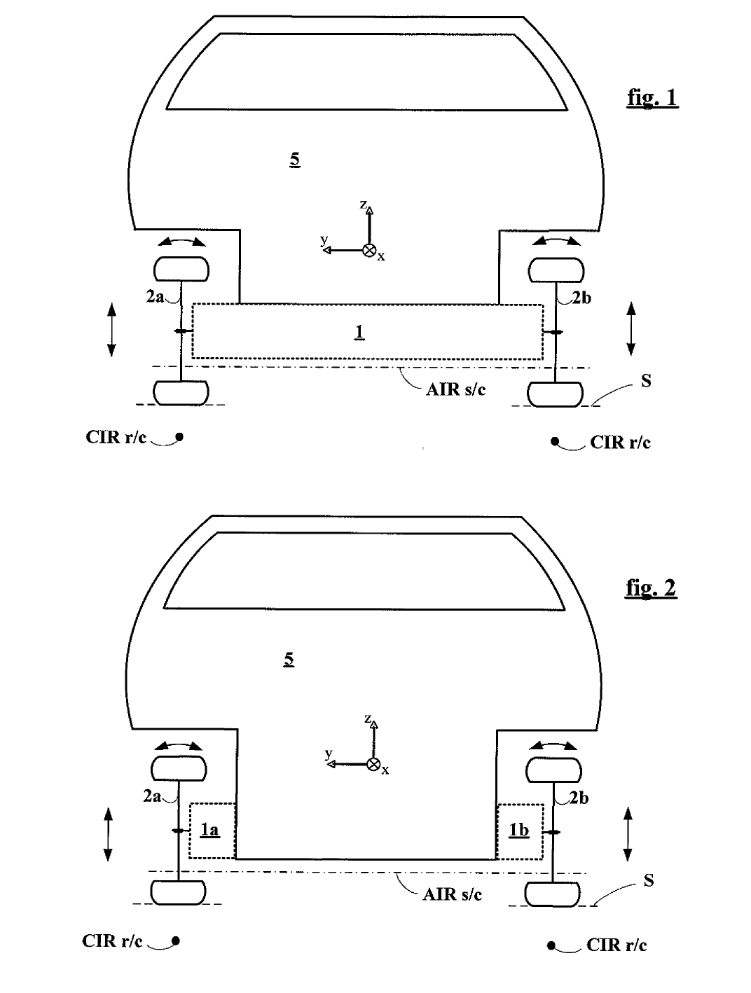

FIGS. 1 and 2 show schematic rear views of vehicles according to the invention;

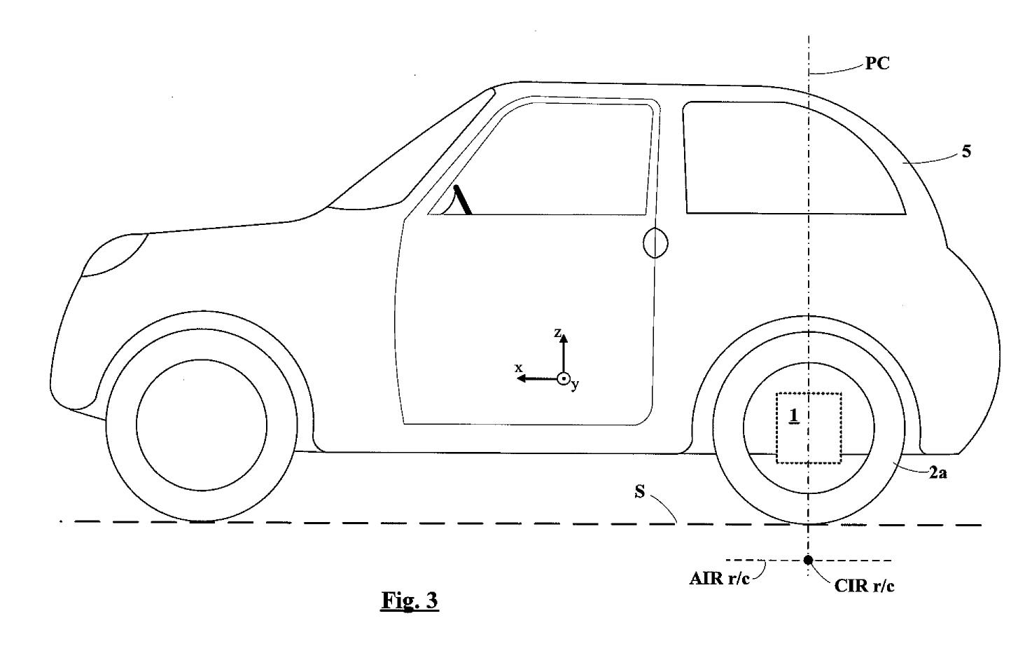

FIGS. 3 to 5 show schematic side views of a vehicle according to the invention, the front of the vehicle being situated to the left of the figures;

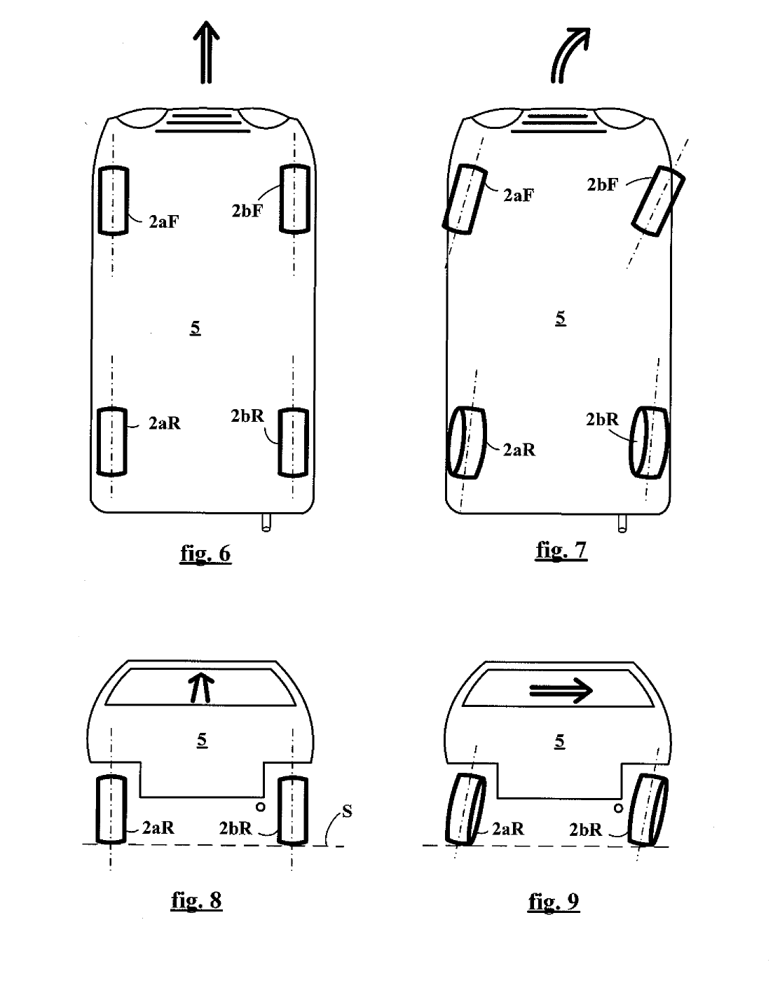

FIGS. 6 and 7 show schematic top views of a vehicle according to the invention; and

FIGS. 8 and 9 show schematic rear views of a vehicle according to the invention.

The various figures use the same reference numbers to denote identical or similar elements. Consequently, these elements will not be described with systematic repetition. Also shown are the axes of the reference frame associated with the vehicle. According to the standard conventions, the X axis is longitudinal and directed towards the front, the Y axis is transverse and directed towards the left, and the Z axis is vertical and directed towards the top.

FIG. 1 schematically shows a rear view of a vehicle according to the invention. The body 5 rests on the ground S by way of a suspension device 1. The suspension device 1 allows the vertical deflection and the variation in camber of each wheel (left 2a and right 2b) in a manner which is either dependent or independent for each wheel. The suspension device is connected to the body by connection means (not shown here). Examples of variable-camber suspension devices configured in this way are described, for example, in FIG. 14 of document WO 01/052666 or in FIG. 10 of document WO 04/009383.

FIG. 2 schematically represents a rear view of a vehicle whose body 5 rests on the ground S by way of two suspension devices (a left-hand device 1a and a right-hand device 1b). Each suspension device allows the vertical deflection and the variation in camber of each wheel (left 2a and right 2b) in a manner which is either independent of or dependent on the other wheel. This representation also illustrates the fact that each of the two suspension devices is connected to the body by connection means (not shown here) specific thereto. Examples of variable-camber suspension devices configured in this way are described, for example, in FIG. 3 of document WO 04/058521, in FIG. 9 of WO 04/009383 or in FIG. 7 of Patent Application FR 2880302.

The wheel camber movement with respect to the body takes place about an instantaneous center of rotation (CIR r/c) preferably positioned below the ground in order that the transverse forces acting on the wheel in the contact area cause the intended variations in camber without any need for a camber actuator.

FIG. 3 shows the left-hand side of a vehicle whose rear axle uses a suspension system according to FIG. 1 or 2. As in the preceding figures, the suspension device is schematically represented by broken lines. This view makes it possible to show the instantaneous axis of rotation (AIR r/c) about which the camber movement of the wheel 2a occurs with respect to the body 5. This axis (which will also be referred to as “camber axis” in the remainder of the application) passes through the point CIR r/c in the plan view shown in FIGS. 1 and 2. The instantaneous axis of rotation is here represented as horizontal, that is to say orthogonal to the camber plane PC. Alternatively, the camber axis can also be slightly inclined in order to generate steering variations at the same time as camber variations.

The explanation which has just been given with reference to FIGS. 1 to 3 corresponds to the prior art.

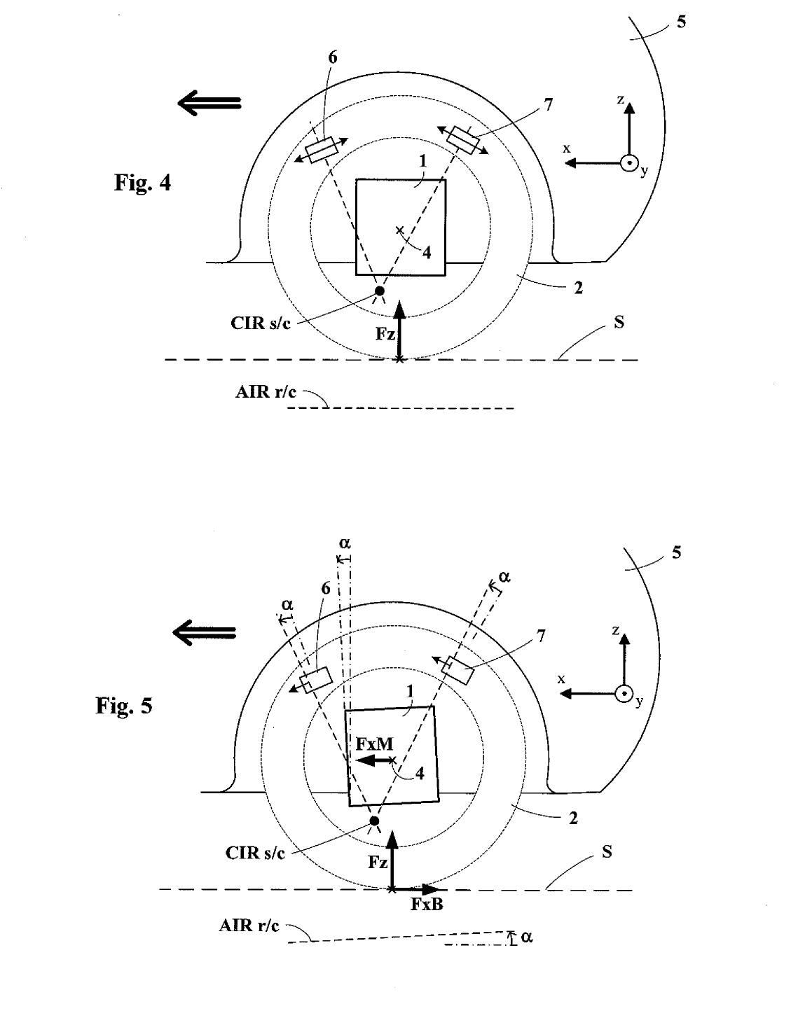

FIGS. 4 and 5 represent a principle of the invention whereby the suspension device 1 is connected to the body in such a way that it can additionally pivot (in its entirety) relative to the body about a transverse axis of rotation in order to vary the inclination of the camber axis. In the left-hand views shown in FIGS. 4 and 5, the transverse axis passes through the point CIR s/c. In the longitudinal views shown in FIGS. 1 and 2, the transverse axis of rotation AIR s/c is clearly visible.

In the example shown in FIGS. 4 and 5 are schematically represented the means of connecting the suspension device to the body, such as elastic articulations 6 and 7 which, for example, each allow a movement along their axis and are configured so as to define the said rotation of the suspension device with respect to the body about the said transverse axis.

A comparison between FIGS. 4 and 5 illustrates the operating principle of the invention. In FIG. 4, the camber axis (AIR r/c) is horizontal. In FIG. 5, the camber axis is inclined towards the front of the vehicle by an angle α corresponding to the pivoting angle α of the suspension device about the transverse axis. It will be understood that this additional mobility function can therefore be used to vary the inclination of the camber axis in an active or passive manner and as a function of many parameters.

In the context of a passive operation, depending on the precise position of the transverse axis, the forces being exerted in the connection between the vehicle and the ground will have a tendency to pivot the suspension device in one or other direction (that is to say towards the front as in FIG. 5 or towards the rear).

Preferably, the transverse axis is situated vertically at least 50 mm above the ground so that the braking forces F×B have the effect of inclining the camber axis towards the front of the vehicle, as represented here.

Preferably, in the case of a driving axle, the transverse axis is situated vertically at least 100 mm below the axis of the wheel 4 so that the driving forces F×M also have the effect of inclining the camber axis towards the front of the vehicle, as represented here.

Preferably again, the transverse axis is additionally situated horizontally slightly in front (for example at least 30 mm) of the center of the wheel 4 so that the vertical forces Fz also have the effect of inclining the camber axis towards the front of the vehicle, as represented here. Preferably, the vehicle is configured in such a way that the variation in vertical load does not have an effect on the inclination of the camber axis as long as the vertical load does not exceed that corresponding to the reference load of the vehicle, that is to say when the vehicle is in full working order (all the fluid reservoirs are full) and is transporting two passengers seated in the front seats.

In the context of an active operation, that is to say when use is made of an actuator to impose a controlled rotation on the suspension device, the position of the transverse axis can be chosen more freely, as a function for example of size and power level criteria specific to this actuator. Active control of the inclination of the camber axis can take place as a function of vehicle running parameters, such as, for example, speed, longitudinal or transverse acceleration of the vehicle, angle at the steering wheel, speed of rotation of the steering wheel, torque exerted on the steering wheel, roll, roll speed, roll acceleration, yaw, yaw speed, yaw acceleration, the forces on the wheels including the vertical load, the type of driving, and the behaviour desired by the driver.

The actuator may be of any type (for example electrical, mechanical, hydraulic), provided that it is suited to the intended application of the invention.

Preferably, the camber axis is substantially horizontal in the absence of variation, and the useful variation (a) in the angle of inclination is at least 5°, preferably still 10°.

The means for connecting the suspension device(s) to the body can take any form which allows a relative rotation about a transverse axis. It has proved to be advantageous to achieve this function by means of elastic connections which, in a manner known per se, connect the subframe(s) of the suspension device or devices to the body of a vehicle. The useful function of these connections is to promote comfort by reducing the transmission of shocks and vibrations. In the context of the invention, the adoption of suitable stiffnesses and a suitable spatial configuration makes it possible to give these connections the additional function of allowing the suspension device to rotate about a transverse axis.

Alternatively, the connection means may, for example, take the form of a curved slideway guide system, the axis of the curvature corresponding to the intended transverse axis of rotation. A plurality of suitably oriented and combined rectilinear slideways may also be used.

The variable-camber suspension device may also comprise an active camber control means, likewise controlled as a function of the vehicle running parameters.

FIGS. 6, 7, 8 and 9 schematically illustrate one possible operating mode of the vehicle according to the invention. FIG. 8 is a rear view of the situation represented in top view in FIG. 6. FIG. 9 is a rear view of the situation represented in top view in FIG. 7. In this example, as in the preceding ones, only the rear axle of the vehicle uses a suspension device according to the invention. In FIGS. 6 and 8, the vehicle is running in a straight line, the steering movement and the camber of its wheels being substantially zero. In FIGS. 7 and 9, the vehicle is travelling around a right-hand bend. Its front wheels (2aF and 2bF) are steered towards the inside of the turn in a conventional manner. The camber axis is inclined towards the front, for example because the driver is braking. Consequently, the rear wheels of the vehicle are inclined towards the inside of the turn (the outer wheel 2aR is in negative camber and the inner wheel 2bR in positive camber) and are likewise steered towards the inside of the turn. The stability of the vehicle (and hence its safety) in the turn is thus promoted.

1. A vehicle comprising a variable-camber suspension device, said suspension device (1) allowing a substantially vertical suspension movement and a camber movement of the wheel (2a) with respect to the body (5) of the vehicle, the vertical suspension movement and the camber movement being substantially independent, wherein the suspension device is connected to the body by connection means (6, 7) allowing a rotation (a) of the suspension device with respect to the body about a transverse axis of rotation (AIR s/c).

2. The vehicle according to claim 1, wherein said connection means are configured so as to allow a rotation of the suspension device with respect to the body about a transverse axis of rotation situated vertically between the ground (S) and the center of the wheel (4).

3. The vehicle according to claim 2, wherein the transverse axis is situated longitudinally in front of the centre of the wheel (4).

4. The vehicle according to claim 3, wherein, with the camber movement of the wheel taking place about an instantaneous axis of rotation (AIR r/c), said connection means are configured such that the instantaneous axis of rotation is substantially horizontal when the wheel does not transmit any braking force and such that the instantaneous axis of rotation is inclined towards the front when the wheel transmits a braking force (F×B).

5. The vehicle according to claim 4, wherein, with the camber movement of the wheel taking place about an instantaneous axis of rotation (AIR r/c), said connection means are configured such that the instantaneous axis of rotation is substantially horizontal when the suspension device bears its reference load and such that the instantaneous axis of rotation is inclined towards the front when the suspension device bears a vertical load which is greater than the said reference load.

6. The vehicle according to claim 5, wherein, with the camber movement of the wheel taking place about an instantaneous axis of rotation (AIR r/c), said connection means are configured such that the instantaneous axis of rotation is substantially horizontal when the wheel does not transmit any driving force and such that the instantaneous axis of rotation is inclined towards the front when the wheel transmits a driving force (F×M).

7. The vehicle according to claim 1, wherein said connection means are elastic articulations, the rotation of the suspension device being brought about by the deformation of the said articulations.

8. The vehicle according to claim 1, wherein the rotation of the suspension device is controlled by active control means as a function of vehicle running parameters.

9. The vehicle according to claim 2, wherein the transverse axis of rotation (AIR s/c) is situated vertically at least 50 mm above the ground (S).

10. The vehicle according to claim 9, wherein the transverse axis of rotation (AIR s/c) is situated vertically at least 100 mm below the axis of the wheel.

11. The vehicle according to claim 3, wherein the transverse axis of rotation (AIR s/c) is situated horizontally at least 30 mm in front of the center of the wheel.

12. The vehicle according to claim 1, wherein said suspension system equips a rear axle of the vehicle.
